(19) United States
(12) Patent Application Publication
(10) Pub. No.: US 2015/0227980 A1
(43) Pub. Date: Aug. 13, 2015

(54) System And Method For Suggesting Comestibles

(71) Applicant: INTERCONTINENTAL GREAT BRANDS LLC, East Hanover, NJ (US)

(72) Inventors: Keith R. Eberhardt, East Hanover, NJ (US); Nathan V. Matusheski, East Hanover, NJ (US); Kristin H. Rubin, East Hanover, NJ (US); Arlene O. Sanoy, East Hanover, NJ (US)

(21) Appl. No.: 14/426,602

(22) PCT Filed: Sep. 27, 2013
(86) PCT No.: PCT/US2013/062134

§ 371 Date: Mar. 6, 2015

Related U.S. Application Data
(60) Provisional application No. 61/707,426, filed on Sep. 28, 2012.

(51) Int. Cl. G06Q 30/02

(52) U.S. Cl. CPC G06Q 30/0269

(57) ABSTRACT

A method for identifying a comestible to a user is provided. The method includes the steps of, by a control circuit: receiving an identification of an activity of the user; receiving duration information for the activity; determining an intensity of the activity; determining a target macronutrient profile based on the intensity and duration of the activity; determining a target energy profile based on the intensity and duration; and identifying at least one comestible having a macronutrient profile that falls within the target macronutrient profile and an energy profile that falls within the target energy profile.

### CROSS-REFERENCE TO RELATED APPLICATION

This application claims the benefit of U.S. Provisional Application No. 61/707,426, filed Sep. 28, 2012 which is hereby incorporated herein by reference in its entirety.

### FIELD

This present application is directed to a system and method for recommending foods to a user based on their physical activity. In this regard, the system and method may take into account the activity intensity and duration, as well as when foods should be ingested relative to timing of the activity.

### BACKGROUND

A number of attempts have been made to coordinate diet planning and activity. In this regard, there have been a number of proposals which restrict overall caloric intake while also increasing physical activity to help a user lose weight. Such methods are not tailored to help the user most effectively achieve the desired goals.

Most lifestyle intervention programs address dietary intake and physical activity as separate aspects, and fall to recognize the complex interaction between diet, physical activity, appetite and energy balance. For example, when a user begins a dietary intervention that includes an energy-restricted diet, they may find it difficult to implement a recommended exercise routine because of increased feelings of hunger and a general lack of energy. When a new exercise routine is started, appetite has been shown to increase. Such increased feelings of hunger may be de-motivating to a user, causing then to consider quitting the plan. It has also been shown that individuals tend to become disinhibited (more willing to “cheat” on their diet) and thus typically compensate for energy expended during physical activity.

In other words, there is a lack of continuity between diet and physical activity recommendations. For example, user who walks for one hour per day would not necessarily need the nutritional requirements of a user who lifts weights for one hour per day. Moreover, a marathon runner may require different caloric intake and macronutrient profiles depending on the amount and duration of specific runs during a training period.

### SUMMARY

The present method and system may be used to recommend one or more foods to a user in a structured way, contrary to traditional diet and exercise planning systems expecting a user to simultaneously restrict food intake and Increase physical activity. Further, the present method and system recommends specific types of foods that are tailored to the type of physical activity being performed. For example, the types of foods recommended for water aerobics would be different than those recommended for walking.

By one approach, a method for identifying a comestible to a user is provided. The method includes the steps of, by a control circuit: receiving an identification of an activity of the user, receiving duration information for the activity; determining an intensity of the activity; determining a target macronutrient profile based on the intensity and duration of the activity; determining a target energy profile based on the intensity and duration; and identifying at least one comestible having a macronutrient profile that falls within the target macronutrient profile and an energy profile that falls within the target energy profile.

According to one approach, a method for identifying a comestible to a user is provided. The method includes the steps of, by a control circuit: receiving at least one characteristic of the user selected from the group consisting of age of the user, gender of the user, and physical fitness of the user; receiving an identification of an activity of the user; receiving duration information for the activity; determining a maximum user performance threshold based on the at least one characteristic; determining an intensity of the activity based on the maximum user performance threshold; determining a target macronutrient profile based on the intensity and duration of the activity, determining a target energy profile based on the Intensity and duration of the activity; identifying at least one comestible having a macronutrient profile that falls within the target macronutrient profile and an energy profile that falls within the target energy profile.

In one approach, a system for identifying a comestible to a user is provided. The system includes a control circuit having an input. The input is configured to receive an identification of an activity of the user and receive duration information for the activity. The control circuit is configured to determine an intensity of the activity, determine a target macronutrient profile based on the intensity and duration of the activity, determine a target energy profile based on the intensity and duration and identify at least one comestible having a macronutrient profile that falls within the target macronutrient profile and an energy profile that falls within the target energy profile.

By one approach, the target macronutrient profile includes a profile for at least one of the group consisting of carbohydrates, fats, proteins, sugars, vitamins, minerals and salts.

According to one approach, the step of determining the intensity of the activity includes determining a maximum oxygen utilization for the user.

In one approach, the maximum oxygen utilization is estimated based on at least one of the user's age, gender and weight.

By one approach, the maximum oxygen utilization is measured via a user fitness test.

In one approach, the Intensity is calculated as a percentage of the user's maximum oxygen utilization.

According to one approach, the step of receiving confirmation if the activity is to take place before or after the user ingests the at least one comestible.

By one approach, the step of identifying at least one comestible includes randomly selecting at least one comestible from a group of comestibles falling within the target macronutrient profile and target energy profile.

In one approach, wherein the step of identifying at least one comestible includes identifying a plurality of comestibles that, when combined, fall within the target macronutrient profile and target energy profile.

### BRIEF DESCRIPTION OF THE DRAWINGS

For the purpose of facilitating an understanding of the subject matter sought to be protected, there are illustrated in the accompanying drawings embodiments thereof, from an inspection of which, when considered in connection with the following description, the subject matter sought to be protected, its construction and operation, and many of its advantages should be readily understood and appreciated.

FIG. 1 is a flow diagram representing one form of a method for suggesting comestibles to a user;

FIG. 2 is a surface plot of kilocalories from protein across a range of exercise intensities and durations for a 35 year-old male;

FIG. 3 is a surface plot of kilocalories from carbohydrates across a range of exercise intensities and durations for a 35 year-old male;

FIG. 4 is a surface plot of kilocalories from fat across a range of exercise intensities and durations for a 35 year-old male;

FIG. 5 is a surface plot of grams of protein across a range of exercise intensities and durations for a 35 year-old male;

FIG. 6 is a table representing target kilocalories and macronutrient distributions for various exercises for a 35 year-old male;

FIG. 7 is an illustration of one form of proposed foods for a 35 year-old male playing 20 minutes of soccer;

FIG. 8 is a graph representing activities from an activity monitor;

FIG. 9 is a table representing comestibles based on the activities found in FIG. 8;

FIG. 10 is an illustration showing bicycle riding for a 35 year-old male;

FIG. 11 is a table representing comestibles based on the activity found in FIG. 10;

FIG. 12 is a diagram representing one method for determining macronutrient profiles for specific activities and durations of activities;

FIG. 13 is a representation of one form of equations used for calculating macronutrients, such as carbohydrates, suitable for different activities and durations;

FIG. 14 is a representation of another form of equations used for calculating macronutrients, such as carbohydrates, suitable for different activities and durations;

FIG. 15 is a representation of one form of calculations for a macronutrient profile for medium-high exercise;

FIG. 16 is a representation of one form of calculations for a macronutrient profile for high-max exercise;

FIGS. 17A and 17B are representations of macronutrient profiles for a 40 year old female for a variety of different durations and intensities; and

FIG. 18 is a representation of macronutrient profiles for various forms of exercise.

Elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention. Certain actions and/or steps may be described or depicted in a particular order of occurrence while those skilled in the art will understand that such specificity with respect to sequence is not actually required. The terms and expressions used herein have the ordinary technical meaning as is accorded to such terms and expressions by persons skilled in the technical field as set forth above except where different specific meanings have otherwise been set forth herein.

### DETAILED DESCRIPTION

Generally, in one form, a system and method have been developed for automatically recommending foods to individuals based on the type and duration of physical activity. The system and method utilize intensity and duration of physical activity to simultaneously compute an optimal caloric content and macronutrient distribution target. The macronutrient target is then used to query a food database for matching foods which are then recommended to a user if they are within a calorie range consistent with the energy expended during the bout of activity. Such a system incentivizes physical activity, addresses the hunger associated with increasing physical activity, and provides balanced recommendations that enable a user to make more successful and sustained lifestyle changes. Further, the food suggestion system allows for specific on-the-fly recommendation of foods that are selected in a way that is custom tailored to an individual and the specific type of exercise (based on exercise intensity and duration) that they have performed or plan to perform.

In one form, the selection of one food over another is primarily driven by the balance of macronutrients, which is customized based on the type of physical activity performed, and also on the energy (kilocalorie) content of the food. By one approach, the system and method recommend foods based on physical activity and specifies that the amount of carbohydrate, fat and/or protein (as a percentage of food kilocalories and/or grams of each) would be varied according to both the intensity and duration of physical activity.

The macronutrients considered as part of the method and system may include fats, carbohydrates, sodium, potassium, protein vitamins, minerals and other macronutrients. In this regard, the macronutrient profile of suggested comestibles may be specifically tailored to specific activities, durations and intensities.

The two primary energy substrates during physical activity are carbohydrate from muscle and liver glycogen stores and fat from intramuscular and plasma fatty acids (released from adipose stores). It has been shown that time and intensity of physical activity are determinants of the proportion of carbohydrate or lipid-derived energy that is utilized during exercise (Achten, J. and Jeukendrup, A. E. Optimizing fat oxidation through exercise and diet. Nutrition 20, 716-727 (2004); Romijn, J. A. et al. Regulation of endogenous fat and carbohydrate metabolism in relation to exercise intensity and duration. Am. J. Physiol 265, E380-391 (1993)). In addition, individuals who have been exercise trained tend to burn a greater proportion of lipid during sub-maximal exercise (Hurley, B. F. et al. Muscle triglyceride utilization during exercise: effect of training. J. App. Physiol 60, 5624-67 (1986)). The amount of carbohydrate or lipid recommended for a food suggestion can be optimally matched to support the type of energy burned, or to provide a greater energy density when required following a longer duration or more intense workout. In other words, a user who is more physically fit may be provided with different suggestions of comestibles than a user who is less physically fit for the same activity. This difference is attributed to the macronutrient profiles that would be appropriate for the differing physical fitness levels.

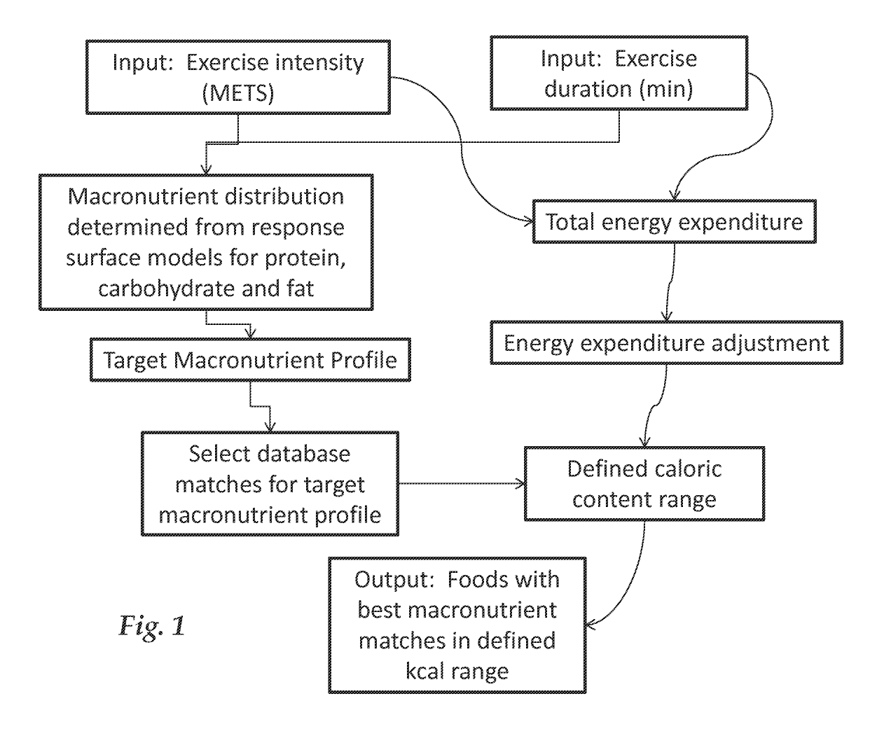

Referring to FIG. 1, a process flow diagram is shown illustrating one form of how type and duration of physical activity may be utilized to create an ideal macronutrient profile and caloric range is detailed in the attached document. In this regard, an exercise is first a recorded by selecting from a list of possible exercises, and a number of minutes is entered by the user to indicate the duration of the bout of exercise. In step 1, a set of pre-determined macronutrient ranges is queried based on the type of exercise performed and the duration of the activity. For example, increased protein content may be recommended for activities with short duration and high intensity. Alternatively, more energy-dense fat-containing foods may be recommended for high-intensity activities of longer duration. Finally, higher carbohydrate foods in line with typical dietary recommendations may be recommended for the lowest-intensity exercises regardless of duration. These macronutrient targets are then used to query a food database for the best matches.

In step 2, the total energy expended from a bout of exercise is calculated. A nutrition score (representing nutrient quality) that correlates with energy intake can alternatively be used in step 2 to filter the list of suggested foods. The best food matches from step 1 are then filtered to obtain a list of foods within a calorie range or nutrition score similar to that of the energy calculated in step 2. One or more of the best-matching foods are then suggested to a user.

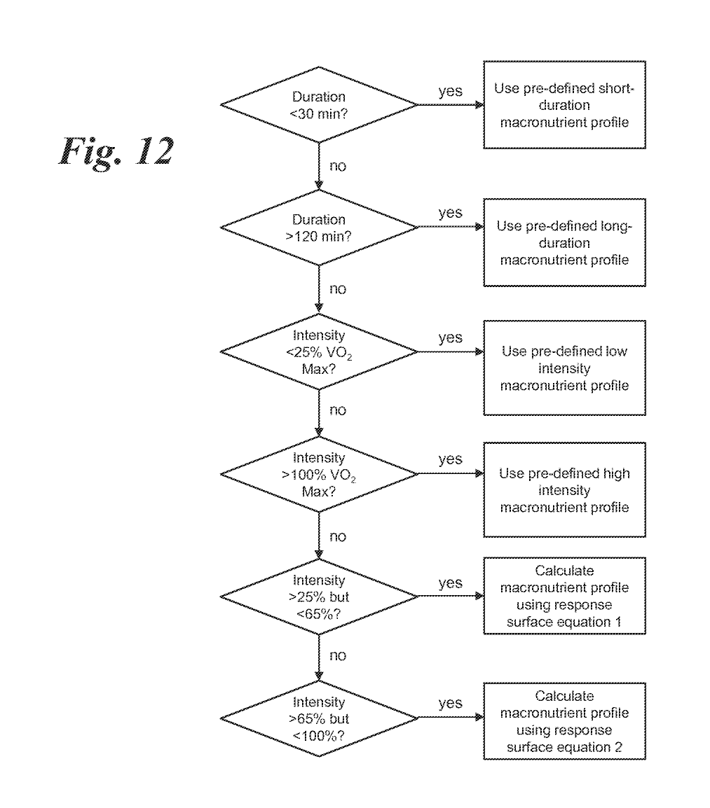

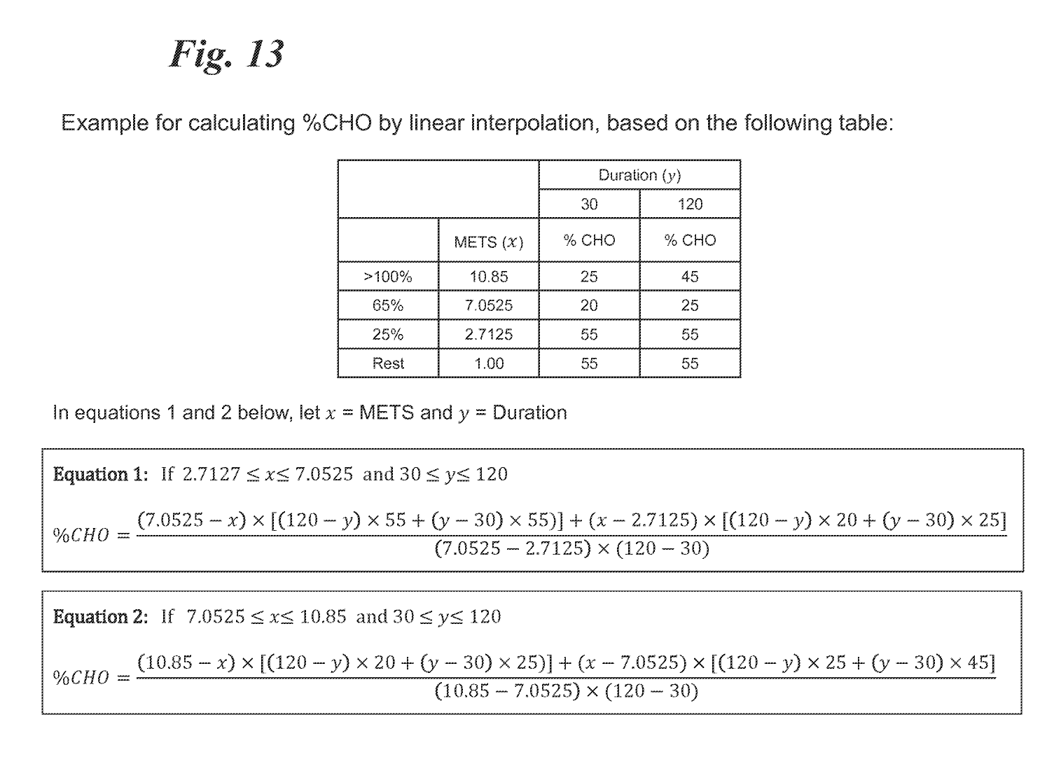

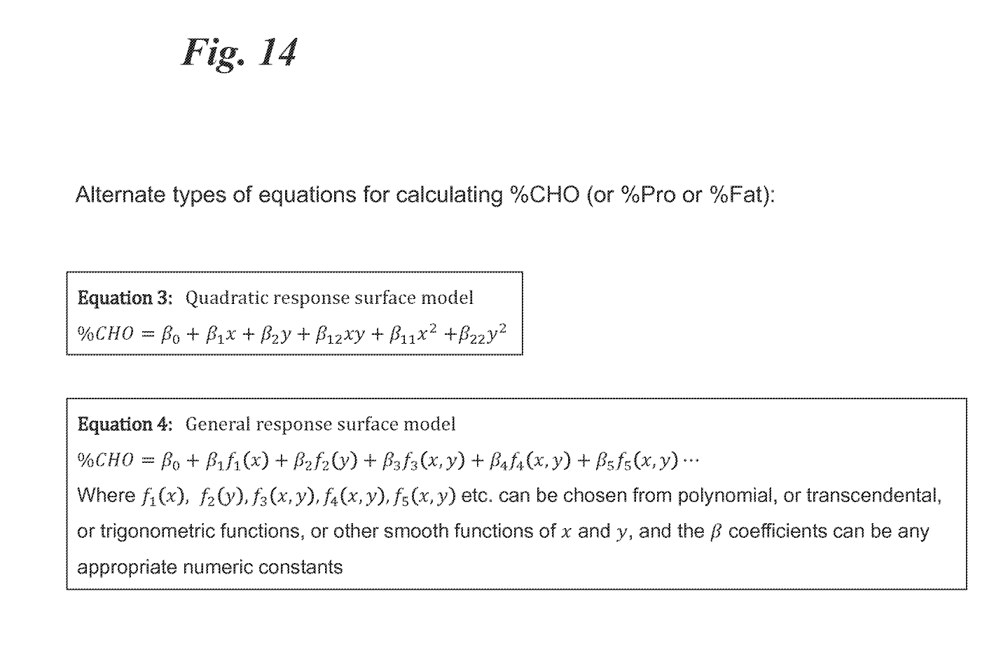

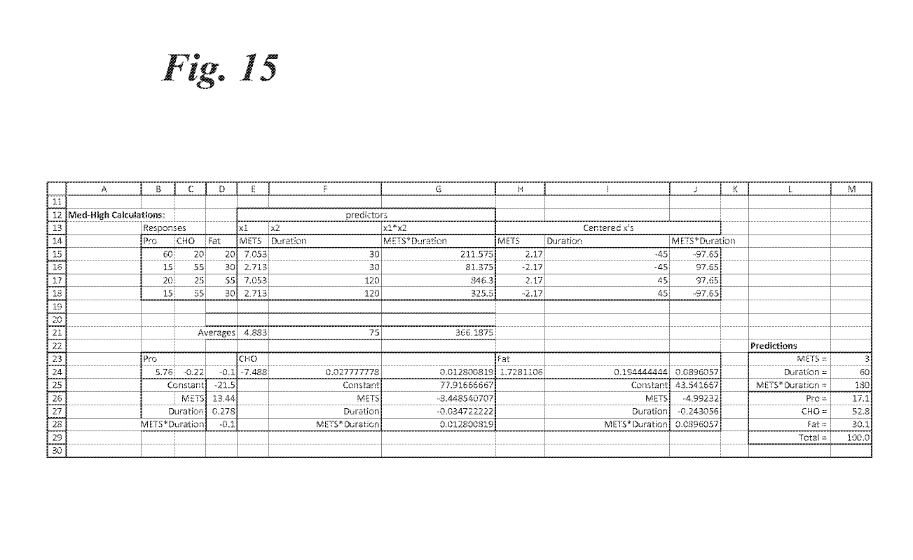

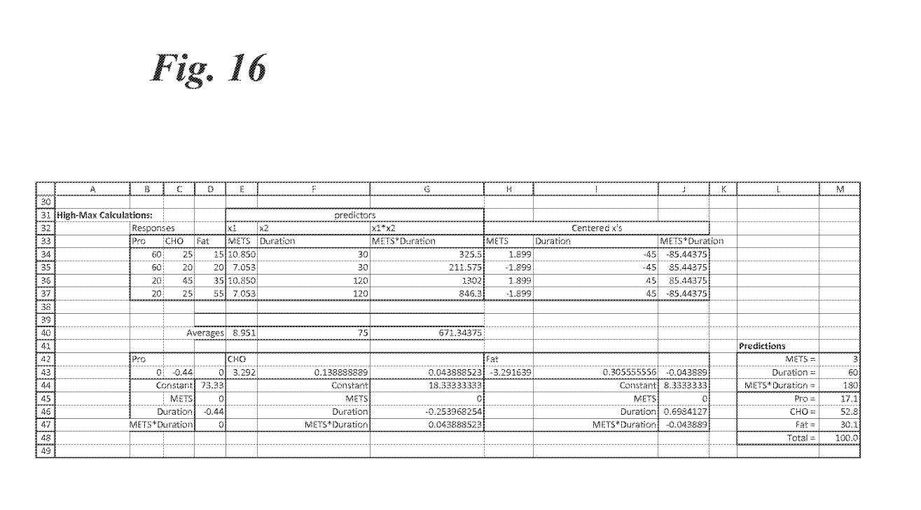

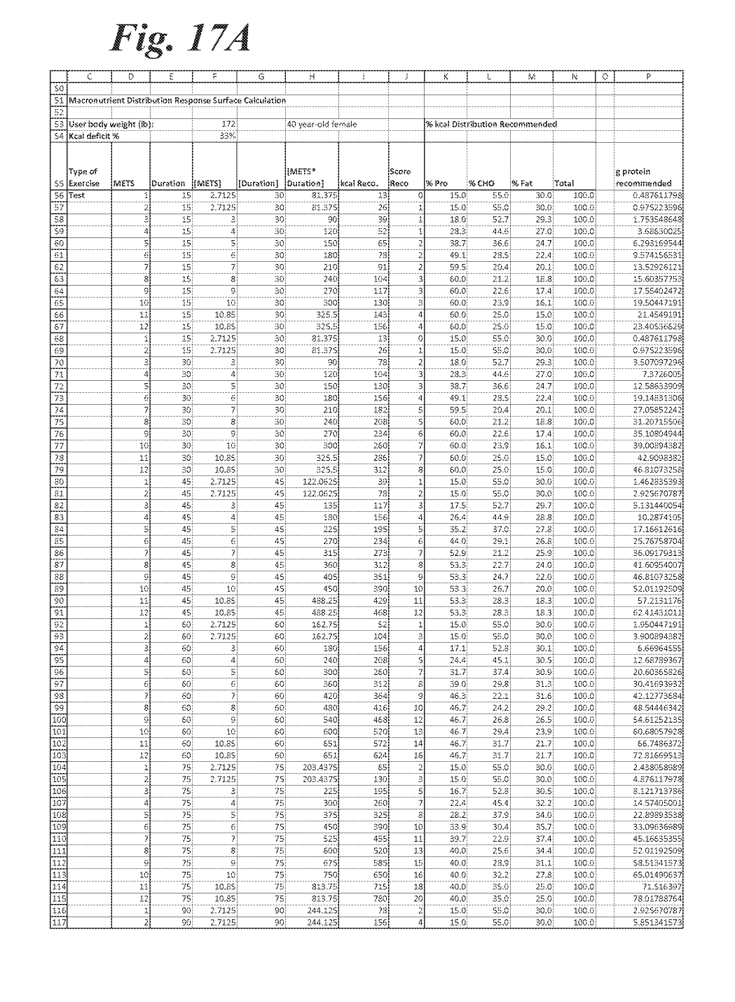

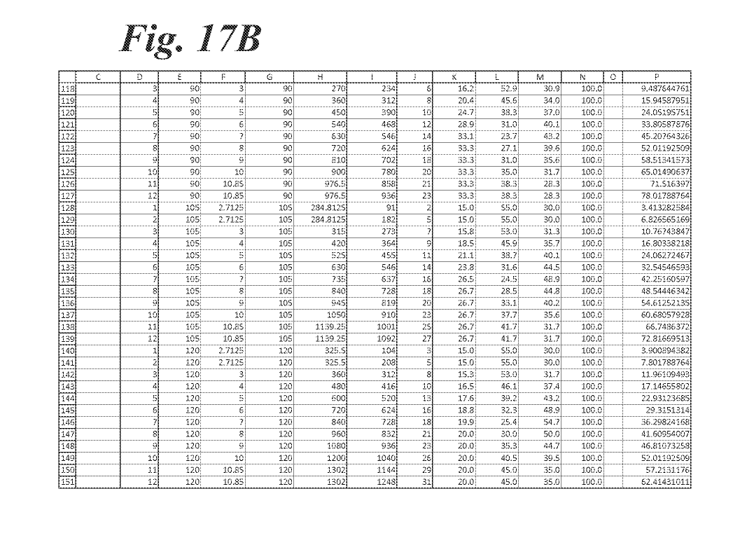

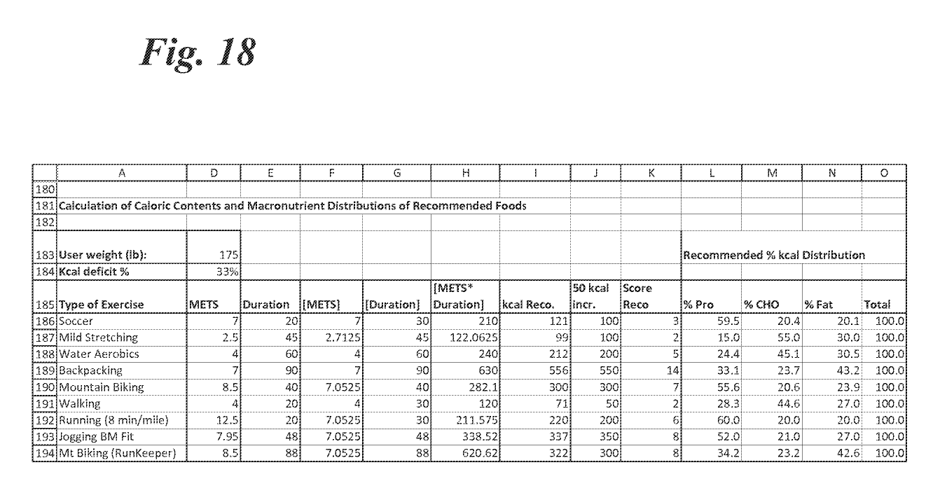

Another form of suggesting foods is shown in FIG. 12. In this form, the duration and intensity of the exercise is used to determine specific profiles and/or equations used for suggesting foods. For example, for certain durations and/or intensities, pre-defined macronutrient profiles may be used, such as for short duration exercise. In other forms, equations may be used to more specifically tailor the macronutrient profile to the intensity and duration. Exemplary profiles and equations are shown in FIGS. 13 and 14.

The system and method may be used to provide individualized food recommendations for a participant, such as of a lifestyle modification program, based on a period of physical activity they perform. In one form, the recommendation may be influenced by the participant's own level of physical fitness. The intensity of various physical activities has been compiled into a publicly available database, within which activities are rated based on metabolic equivalents (METs). METS, or metabolic equivalents, are a measure of energy expended per unit time from a physical activity. 1 MET is equivalent to 4.184 kJ/kg/hr.

Exercise intensity is ultimately individualized based on an individual's level of physical fitness, typically expressed as a percentage of maximal oxygen utilization or VO₂ max in ml/kg/min. In this regard, in one form, each user may undergo a fitness test to determine the specific maximal oxygen utilization. However, normative values exist for the physical fitness across a range of age for reference populations. For example, Morris, C. K. et al. Nomogram based on metabolic equivalents and age for assessing aerobic exercise capacity in men. J. Am. Coll. Cardiol. 22, 175-182 (1993) and Gulati, M. et al. The prognostic value of a nomogram for exercise capacity in women. N. Engl. J. Med. 353, 468-475 (2005) have developed relationships for men and women as follows.

For males: METs at 100% VO₂ max=14.7−(0.11*Age)

For females: METs at 100% VO₂ max=14.7−(0.13*Age)

Generally, as exercise intensity increases, the macronutrient composition that is recommended by the system would depend upon the duration of the activity. Low-intensity exercise has benefits for increasing energy expenditure, but does not substantially change energy substrate utilization in the body (Romijn, J. A. et al. Regulation of endogenous fat and carbohydrate metabolism in relation to exercise intensity and duration. Am. J. Physiol 265, E380-391 (1993)). The principal attribute of a food recommended for a low-intensity physical activity, regardless of duration, would be a low energy density (kcal/g). Therefore, foods containing higher carbohydrate and lower protein and fat, would be preferred. For example, for a 35 year-old male, such a food would contain 55% (variably 45-65%) carbohydrate, 30% (variably 20-35%) fat and 15% (variably 10-35%) protein.

As exercise intensity increases, the macronutrient composition that is recommended by the system would depend upon the duration of the activity. In one form, the system and method defines short-duration exercise as less than 30 minutes (variably less than 15-60 minutes). Short-duration high-intensity exercise has been shown not to induce substantial changes in carbohydrate and lipid utilization. Therefore, even at high intensity, the ratio of recommended carbohydrates and lipids would not change substantially.

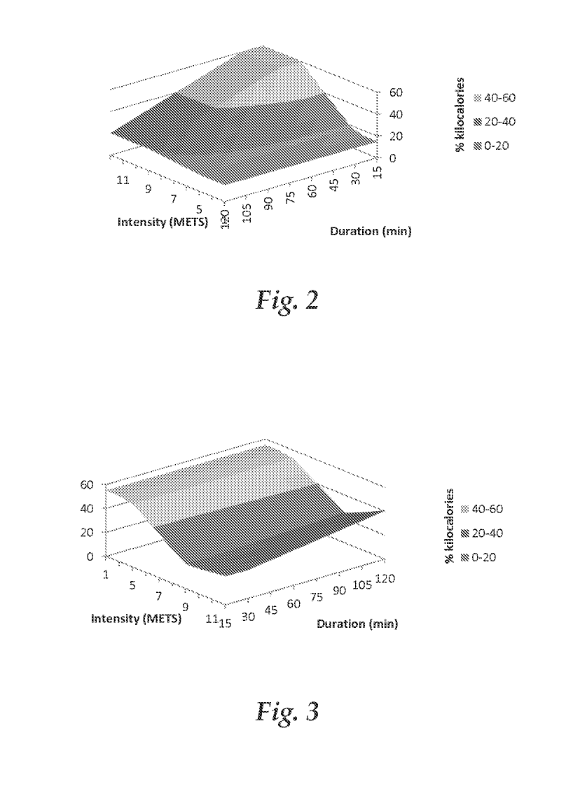

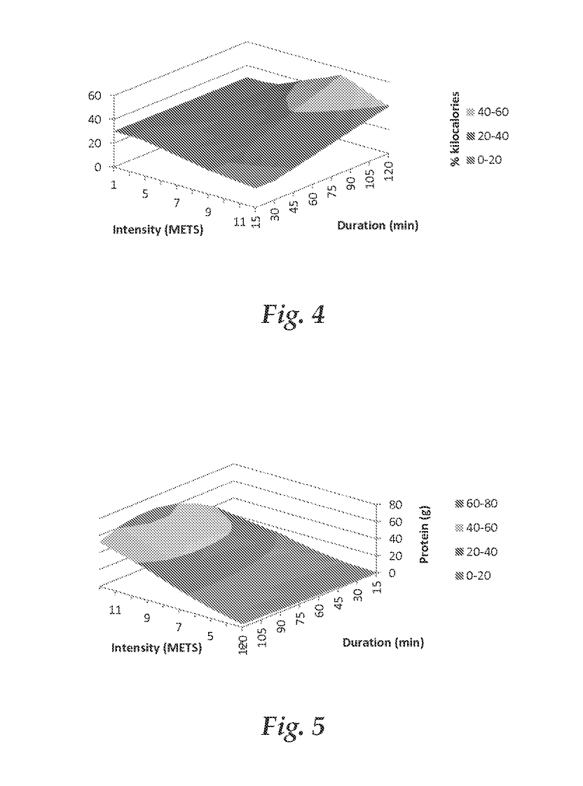

Short-duration, high-intensity exercise has been shown not to induce substantial changes in carbohydrate and lipid utilization. Therefore, in one form, even at high intensity, the ratio of recommended carbohydrates and lipids would not change substantially. See, for example, FIG. 2 which illustrates kilocalories from protein across a range of exercise intensities and durations for a 35 year-old male. FIG. 3 represents kilocalories from carbohydrates across a range of exercise intensities and durations for a 35 year-old male. FIG. 4 represents kilocalories from fat across a range of exercise intensities and durations for a 35 year-old male. Similar plots may also be made for different ages, physical condition, sex and the like. For example, a female would expend less energy for the same period of physical activity as a male, and an older person less than a younger person because of differences in the underlying basal metabolic rate. Such an adjustment could be easily applied to such calculations by way of the well-known Harris-Benedict of Mifflin-St. Jeor equations for predicting basal energy expenditure.

In one form, long-duration exercise may be defined as greater than 120 minutes (variably 60-240 minutes). Over a longer duration, high-intensity exercise it is believed that there are changes in the utilization of endogenous energy substrates compared to low intensity exercise. For example, carbohydrate utilization may gradually decrease, and fat utilization may gradually increase over time in individuals exercising up to 65% of their VO₂ max. Likewise, increasing from low-intensity to high-intensity physical activity may decrease carbohydrate and Increase lipid utilization. However, increasing exertion levels above 65% of VO₂ max may moderately decrease lipid utilization.

Thus, in one form, as duration increases from 30-120 minutes and intensity increases to 65% (variably 50-75%) of VO₂ max, a greater ratio of fat to carbohydrate is recommended. See, for example, Romijn, J. A. et al. Regulation of endogenous fat and carbohydrate metabolism in relation to exercise intensity and duration. Am. J. Physiol 265, E380-391 (1993). Above 65% VO₂ max, the recommended lipid content then gradually decreases. Other equations are shown in FIGS. 13 and 14. Foods that specifically match these macronutrient profiles would therefore be selected from a food database using a multidimensional attribute matching approach.

Many physiologic and nutritional factors contribute to the degree to which muscles recover function following a period of exercise, including muscle damage, connective tissue, cellular and neural effects. It has been thought that 10-50 g of supplemental protein, within two hours following a period of exercise, can lead to enhanced muscle recovery. In one form, the present system and method uses exercise intensity and duration together as a proxy for the degree to which an exercise challenge may lead to a nutrient need for muscle recovery from a specific exercise. Other equations are shown in FIGS. 13 and 14.

Low-intensity exercises do not typically result in large changes in muscle accretion. Thus for low intensity exercises, in one form, the present system and method may recommend that the percentage of kilocalories as protein should be 15% (variably 0-30%) following low intensity exercises of any duration. After a period of short-duration, high-Intensity exercise, as defined above, a greater degree of muscle damage and/or muscle stimulation may occur, leading to the need for an increased protein requirement. Therefore, higher protein foods could be selected. Other equations are shown in FIGS. 13 and 14.

For high-intensity short-duration exercises (30 minutes), as exercise intensity increases, the percentage of kilocalories as protein may increase to 60% (variably 40-80%). For high-intensity long-duration exercises (>120 minutes), as exercise intensity increases, the percentage of kilocalories as protein may increase, but not as much as that of a short-duration exercise, due to the allowance for increased carbohydrate and lipid energy sources. Thus, percentage of kilocalories as protein may increase to 20% (variably 1040%). The number of grams of protein recommended for a 35 year-old male performing various intensities of exercise across a range of durations is provided in FIG. 5. Other equations are shown in FIGS. 13 and 14.

In one form, foods may be categorized into 50 kcal increments (±25 kcal) for the purpose of a specific recommendation. Depending upon the total amount of energy expended during a period of exercise, a specific group of foods would be eligible for a recommendation, based on their single-serving kilocalorie content. Grouping foods in this way favors foods with increased amounts of fiber and water because of their lower energy density.

Because a recommended food is intended to be added on top of a lifestyle modification system, it is preferable to include an energy restriction parameter that factors in to the recommended calorie calculation derived from the specific intensity and duration of exercise. In one form, the system and method may utilize a caloric restriction of −33%. In another form, this could vary from a restriction of −50% to an excess of +25% beyond the calculated energy expenditure. Thus, the number of grams of protein, or any of the other macronutrients, would vary depending upon how the overall caloric restriction factor was varied to suit the needs of the particular dietary or behavioral program.

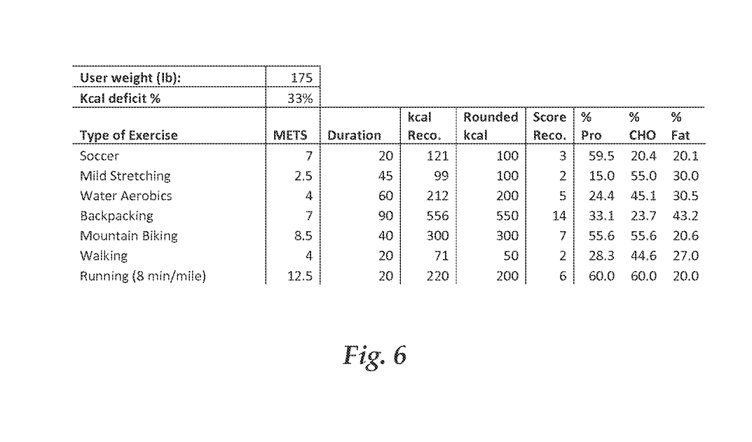

The system and method may match foods to exercises by first defining a target macronutrient profile and food-energy requirement as described above. FIG. 6 illustrates several example exercises with their respective recommended macronutrient parameters, again using a 35 year-old male who weighs 175 pounds, by way of example.

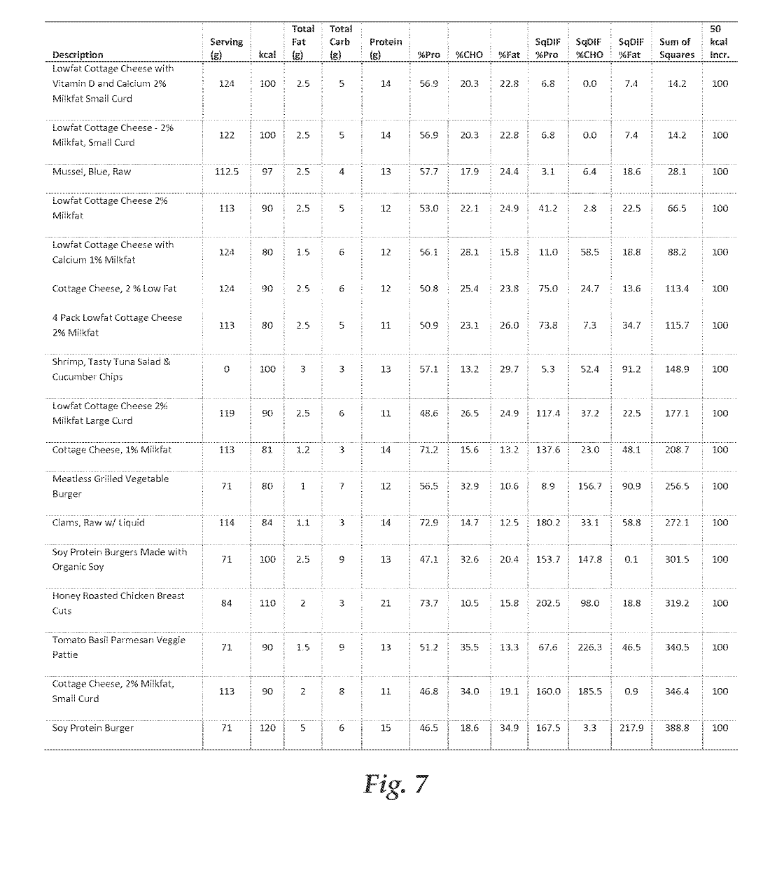

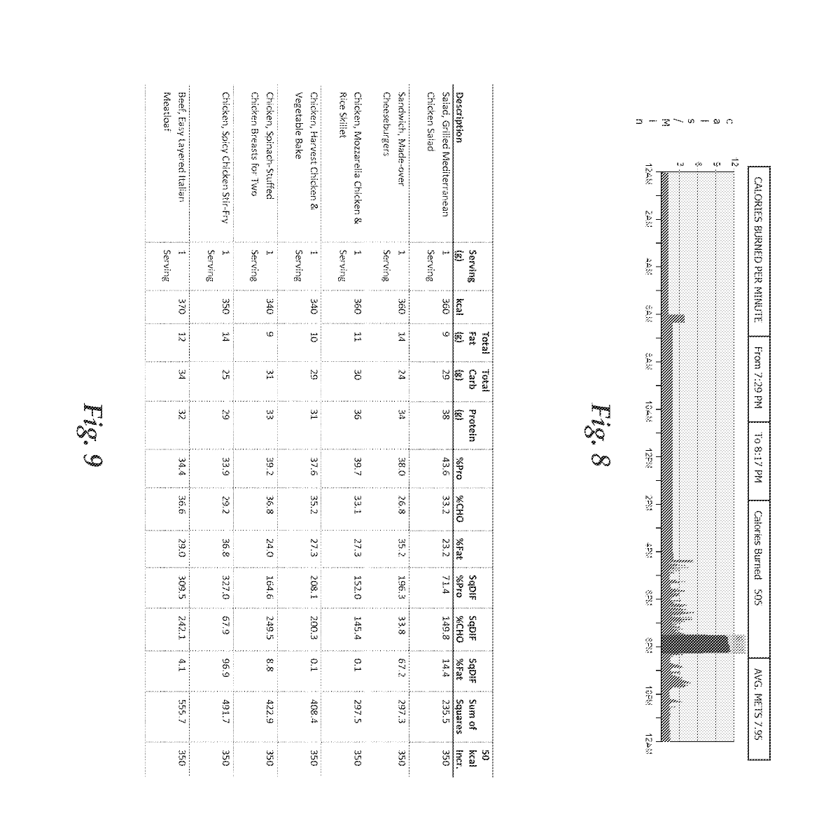

After targets have been generated, the system creates a database match by minimizing the sum of squared difference between the target macronutrient profile and that of a food in the database. See, for Example, FIG. 7 which represents food choices for a 35 year-old male playing soccer. Other mathematical or statistical processes could also be used to achieve a match for a food with the most suitable macronutrient content. Only foods that fall within the recommended 50 kcal increment (in this case food servings containing 100±25 kcal) are suggested to the user. In this example, the best match food would be a 124 g serving of Breakstone's low fat cottage cheese. If the user does not like the first suggestion, they can hit a button “Show me another food” and the system will provide a second, third, fourth and so-on recommendation. The system can also be programmed to randomize the top, e.g., 10 food suggestions in order to keep the subject engaged.

Electronic devices are currently available that track a user's energy expenditure throughout the day by way of monitoring physiological parameters such as heart rate and/or gyroscopic motion of the device. Such devices include the BodyMedia Fit/GoWear Fit (BodyMedia, Inc., Pittsburgh, Pa.), Body Bugg (24 Hour Fitness, Carlsbad, Calif.), FitBit (Fitbit, Inc., San Francisco, Calif.), DirectLife (Philips Electronics North America, Andover, Mass.), Zeo (Zeo Inc., Newton, Mass.), and Polar FA 20 (Polar Electro Inc., Lake Success, N.Y.). Such devices provide a report of energy expenditure following daily activities and also routine and strenuous physical activities in units of energy expenditure per minute.

The present system and method may be configured to be compatible with such devices. A pre-determined threshold energy expenditure per unit time (e.g., kcals per minute) can be defined by the participant or derived from the participant's characteristics and normative values for VO₂ max. When the threshold is exceeded, the Intensity and duration of the period of physical activity can be automatically used to generate a food recommendation that is specific to the type of physical activity that was performed.

For example, a 35 year-old male weighing 175 pounds wore an activity monitor (BodyMedia Fit) from 4:30 pm into the following day. A jogging activity was performed between 7:29 pm and 8:17 pm (48 minutes), and would be detected with an activity threshold of 6 kcals/min. The average METs for this activity was 7.95 and the system reported a total energy expenditure of 505 kcals. These details are represented in FIG. 8.

Based on the above period of exercise, and using one form of the present system and method, a food with an energy content of 350±25 kcal would be recommended, with 52% protein, 21% carbohydrate and 27% fat. Foods matching this profile are listed in FIG. 9.

Similarly, smartphone applications currently exist that enable a user to track their periods of physical activity using GPS and related technology. Such exercise tracking applications include RunKeeper (FitnessKeeper, Inc., Boston, Mass.), Nike+ GPS (Nike, Inc., Beaverton, Oreg.), Garmin Connect (Garmin Ltd., Olathe, Kans.), Endomondo (Endomondo ApS, Copenhagen, Denmark), Cardiotrainer (WorkSmart Labs, New York, N.Y.) and Runtastic (Runtastic GmbH, Linz, Austria). Many such applications also allow a user to specify a type of physical activity they plan to track. The application records the time, location and speed of the activity, and provides a summary report to the user. The present system and method may be configured to be compatible with such an application. The tracking application would provide information on the type and duration of physical activity that the user performs. A user's personal profile could also be stored in the application. In addition, the GPS tracking could also provide an even more accurate estimation of exercise intensity based on the instantaneous or average speed the user is traveling and the instantaneous or average changes in altitude the user has made. For example, the exercise intensity of bicycling at <10 mph would be considered relatively low (4.0 METs) while uphill mountain biking would be considered to be very high intensity (14.0 METs).

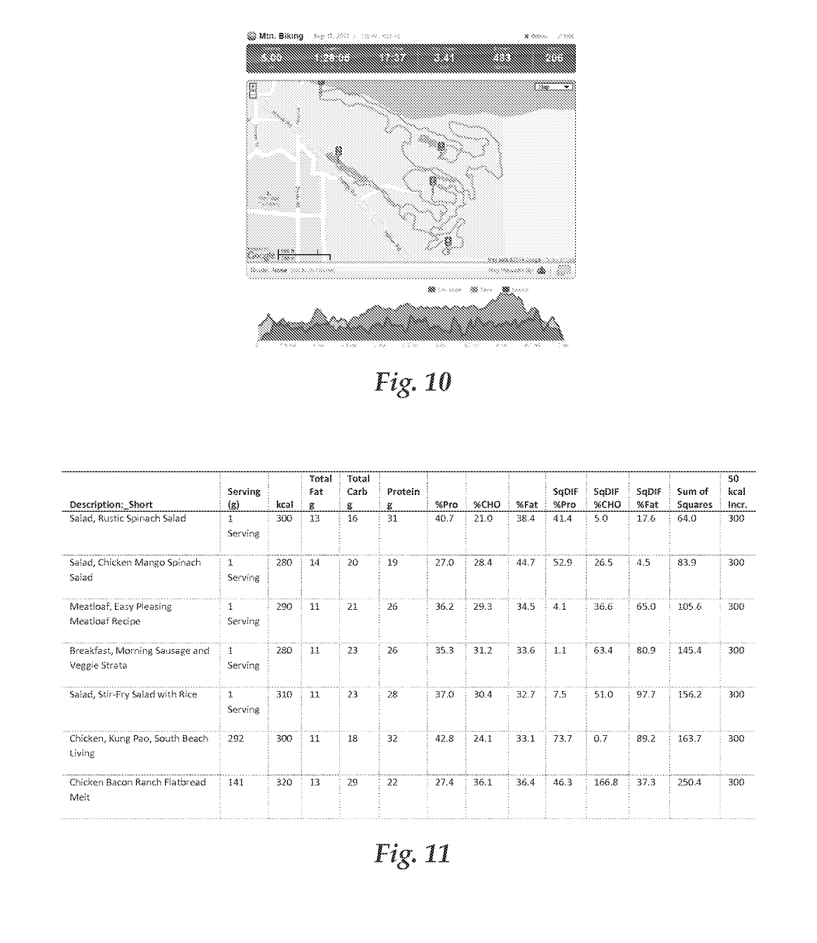

For example, a 35 year-old male completed a bicycle ride lasting 1 hour 28 minutes with an average speed of 3.41 mph. The activity was tracked in the RunKeeper Phone application, and the system reported a total energy expenditure of 483 kcal as illustrated in FIG. 10. Based on the above period of exercise, and using one form of the present system and method, one or more foods with an energy content of 300±25 kcal would be recommended, with 34.2% protein, 23.2% carbohydrate and 42.6% fat. Foods matching this profile are listed in FIG. 11.

Macronutrient ranges and endpoints for intensity and duration of exercise could be varied to suit the needs of a specific lifestyle intervention program. The response surface could also utilize a non-linear adjustment to further refine suggested macronutrient composition. Finally, a categorical recommendation to consume the additional food either before or after the bout of exercise could also be included, based on intensity and duration of exercise in a similar way to the method described above.

The method described here allows increased flexibility in meal planning based on the type and duration of physical activity by recommending the consumption of foods that are customized not only to the energy expended during exercise, but also the type of exercise that is performed. In this way, an increased level of physical activity during a given time period would provide an incentive by way of a specific amount and type of increased food intake being recommended to the user. This method could also be combined with methods for incentivizing physical activity such as rewards points, team competitions for minutes of activity, and other forms of support.

One form of the components of the system will now be described. The system may include a control circuit, a memory and a network interface. The system also optionally includes or otherwise is operably connected to a user interface whereby a user may access the system. It should be noted that the user interface may be located remotely from the system, such as at a third party's computer, mobile phone, laptop and the like.

The system may take a variety of forms including, but not limited to, one or more servers, computers, portions of servers or computers, and the like as understood by those skilled in the art. The system may also take the form of a mobile phone, tablet, portable or other electronic device. For example, the system may be a server whereby a user may access the system via his or her mobile device. Alternatively, the system may take the form of the user's mobile device that accesses a server or database remotely or a retailer's computer system.

The control circuit may also take a variety of forms including, but not limited to, one or more processors, hardware, software and the like. The present teachings will readily accommodate using a control circuit that comprises a dedicated-purpose hard-wired platform or a partially or wholly-programmable platform as desired. The memory may also take a variety of forms including, but not limited to, one or more electronic memory units including but not limited to read-only memory (ROM), random-access memory (RAM), hard drive(s), and the like. The memory may be operably coupled to the control circuit to provide data, access to one or more databases, and other information to the control circuit. The network interface may also take a variety of forms including, but not limited to, a modem, Ethernet, Wi-Fi, cellular, satellite and other electronic communications forms. For example, the network interface may be configured to interface with a wide-area network (WAN), a local-area network (LAN), the Internet, SMS/MMS messaging, cellular connections, social networks and the like.

### EXAMPLES

### Example 1

For simplicity of describing the present system and method, Example 1 assumed METs corresponding to 100% VO₂ max and percentages thereof for a 35 year-old male (10.85 METs).

Definitions for what is considered low, medium or high intensity physical activity are given in Table 1. For the purposes of this food recommendation system, we define low-intensity physical activity as less than 25% of an individual's VO₂ max (the cut-off for low-intensity activity could variably be described as 0-50% of VO₂ max). Based on the 35 year-old male example we described above, this equates to exercises rated at less than 2.71 METs. We also define high-intensity physical activity as greater than 65% of an Individual's VO₂ max (the cut-off for high-intensity activity could variably be described as 50-100% of VO₂ max). Based on the 35 year-old male example we described above, this equates to exercises rated at greater than 7.05 METs. A food recommendation based on an exercise intensity greater than an individual's VO₂ max would be the same as that recommended for 100% VO₂ max in our system.

TABLE 1
Cut-offs for low, medium or high intensity physical activity,
with an individual example for a 35 year-old male participant.

| | | METs for a 35 year-old |
|---|---|---|
| Exercise intensity | VO₂ max | male |
| Low | 0-25% | 0-2.71 |
| Medium | 25-65% | 2.71-7.05 |
| High | 65-100% | 7.05-10.35 |
| Very High | >100% | >10.85 |

The principal attribute of a food recommended for a low-intensity physical activity, regardless of duration, would be a low energy density (kcal/g). Therefore, foods containing higher carbohydrate and lower protein and fat, would be preferred. Ideally such a food would contain 55% (variably 45.65%) carbohydrate, 30% (variably 15.45%) fat and 15% (variably 0-30%) protein (Table 2).

TABLE 2
Definition of Macronutrient Distribution Response
Surface* - Example METs for a 35 year-old male

| | | | Duration | | | | | |
|---|---|---|---|---|---|---|---|---|
| | | | 30 minutes | | | 120 minutes | | |
| | | METS | % Pro | % CHO | % Fat | % Pro | % CHO | % Fat |
| Very high cut | >100% | >10.85 | 60 | 25 | 15 | 20 | 45 | 35 |
| Med-High cut | 65% | 7.05 | 60 | 20 | 20 | 20 | 25 | 55 |
| Low-Med cut | 25% | 2.71 | 15 | 55 | 30 | 15 | 55 | 30 |
| | Rest | 1.00 | 15 | 55 | 30 | 15 | 55 | 30 |

Those skilled in the art will recognize that a wide variety of modifications, alterations, and combinations can be made with respect to the above described embodiments without departing from the spirit and scope of the invention, and that such modifications, alterations, and combinations are to be viewed as being within the ambit of the inventive concept.

1. A method for identifying a comestible to a user, the method comprising the steps of:
by a control circuit:
receiving an identification of an activity of the user;
receiving duration information for the activity;
determining an intensity of the activity;
determining a target macronutrient profile based on the intensity and duration of the activity;
determining a target energy profile based on the intensity and duration; and
identifying at least one comestible having a macronutrient profile that falls within the target macronutrient profile and an energy profile that falls within the target energy profile.

2. The method of claim 1 wherein the target macronutrient profile includes a profile for at least one of the group consisting of carbohydrates, fats, proteins, sugars, vitamins, minerals and salts.

3. The method of claim 1 wherein the step of determining the intensity of the activity includes determining a maximum oxygen utilization for the user.

4. The method of claim 3 wherein the maximum oxygen utilization is estimated based on at least one of the user's age, gender and weight.

5. The method of claim 3 wherein the maximum oxygen utilization is measured via a user fitness test.

6. The method of claim 3 wherein the intensity is calculated as a percentage of the user's maximum oxygen utilization.

7. The method of claim 1 further comprising the step of receiving confirmation if the activity is to take place before or after the user ingests the at least one comestible.

8. The method of claim 1 wherein the step of identifying at least one comestible includes randomly selecting at least one comestible from a group of comestibles falling within the target macronutrient profile and target energy profile.

9. The method of claim 1 wherein the step of identifying at least one comestible includes identifying a plurality of comestibles that, when combined, fall within the target macronutrient profile and target energy profile.

10. A method for identifying a comestible to a user, the method comprising the steps of:
by a control circuit:
receiving at least one characteristic of the user selected from the group consisting of age of the user, gender of the user, and physical fitness of the user;
receiving an identification of an activity of the user;
receiving duration information for the activity;
determining a maximum user performance threshold based on the at least one characteristic;
determining an intensity of the activity based on the maximum user performance threshold;
determining a target macronutrient profile based on the intensity and duration of the activity;
determining a target energy profile based on the intensity and duration of the activity; and
identifying at least one comestible having a macronutrient profile that falls within the target macronutrient profile and an energy profile that falls within the target energy profile.

11. The method of claim 1 wherein the target macronutrient profile includes a profile for at least one of the group consisting of carbohydrates, fats, proteins, sugars, vitamins, minerals and salts.

12. The method of claim 10 further comprising the step of receiving confirmation if the activity is to take place before or after the user ingests the at least one comestible.

13. The method of claim 10 wherein the step of identifying at least one comestible includes randomly selecting at least one comestible from a group of comestibles falling within the target macronutrient profile and target energy profile.

14. The method of claim 10 wherein of identifying at least one comestible includes identifying a plurality of comestibles that, when combined, fall within the target macronutrient profile and target energy profile.

15. A system for identifying a comestible to a user comprising:
a control circuit including an input,
the input configured to receive an identification of an activity of the user and receive duration information for the activity,
the control circuit configured to determine an intensity of the activity, determine a target macronutrient profile based on the intensity and duration of the activity, determine a target energy profile based on the intensity and duration and identify at least one comestible having a macronutrient profile that falls within the target macronutrient profile and an energy profile that falls within the target energy profile.

16. The system of claim 15 wherein the target macronutrient profile includes a profile for at least one of the group consisting of carbohydrates, fats, proteins, sugars, vitamins, minerals and salts.

17. The system of claim 15 wherein the control circuit determines the intensity of the activity based on a maximum oxygen utilization for the user.

18. The system of claim 17 wherein the maximum oxygen utilization is estimated based on at least one of the user's age, gender and weight.

19. The system of claim 17 wherein the control circuit calculates the intensity as a percentage of the user's maximum oxygen utilization.

20. The system of claim 15 wherein the control circuit is further configured to receive confirmation if the activity is to take place before or after the user ingests the at least one comestible.

21. The system of claim 15 wherein the control circuit is further configured to randomly select at least one comestible from a group of comestibles falling within the target macronutrient profile and target energy profile.

22. The system of claim 15 wherein the control circuit is further configured to identify a plurality of comestibles that, when combined, fall within the target macronutrient profile and target energy profile.
